(19) United States
(12) Patent Application Publication
(10) Pub. No.: US 2024/0132984 A1
(43) Pub. Date: Apr. 25, 2024

(54) A method of manufacturing of a steel product in several steelmaking units

(71) Applicant: ArcelorMittal, Luxembourg (LU)

(72) Inventors: Hugo DA GAMA CAMPOS, London (GB); Jean-Martin VAN DER HOEVEN, Luxembourg (LU)

(21) Appl. No.: 18/278,027

(22) PCT Filed: Feb. 23, 2022
(86) PCT No.: PCT/IB2022/051597

§ 371 Date: Aug. 20, 2023

(30) Foreign Application Priority Data
Feb. 26, 2021 (WO) PCT/IB2021/051613

(51) Int. Cl. C21C 5/52; C21B 5/00; C21B 5/06; C21B 13/00; C21C 5/38; C21C 5/46

(52) U.S. Cl. CPC C21C 5/527; C21B 5/006; C21B 5/008; C21B 5/06; C21B 13/0073; C21C 5/38; C21C 5/4673; C21B 2300/04; C21C 2100/02; C21C 2300/06

(57) ABSTRACT

A method of manufacturing a steel product into at least two different steelmaking units wherein an expected level of CO2 emissions for the manufacturing of said product in each respective steelmaking unit is calculated.

The invention is related to a method of manufacturing steel.

### BACKGROUND

The steel industry, like many other human activities, is a source of CO2 emission in the atmosphere. Many technologies are implemented or under development to decrease those CO2 emissions at different levels of the production, through for example recycling of blast furnace, coke oven or converter top gas. This recycling may be performed, after appropriate treatments, by injection into another steelmaking device or use as syngas for other productions.

These technologies aim to decrease direct CO2 emissions of the manufacturing of steel products.

### SUMMARY OF THE INVENTION

However, customers of such steel products, such as car makers, also have to reduce the carbon footprint of their products and to do so request steel products fulfilling all their usual standards in terms of physical properties and quality, but also in terms of carbon footprint. This CO2 carbon footprint is not limited to the direct emissions of the manufacturing process itself.

There is so a need for a method allowing to determine and reduce the CO2 footprint of steel products.

The present invention provides a method wherein a steel product is manufactured in at least two steelmaking units and the method includes a calculation step wherein an expected level of CO2 emissions is calculated to manufacture the steel product in each steelmaking unit, such calculation being done considering all CO2 contributions associated to raw materials, energy sources and processes used for manufacturing the steel product in each respective steelmaking unit and manufacturing the steel product into the steelmaking unit wherein the calculated expected level of CO2 emissions Eexpi is the lowest.

The method of the invention may also comprise the following optional characteristics considered separately or according to all possible technical combinations:
raw materials are chosen among coal, coke, iron ore, biomass, sintered ore, agglomerates, pellets, direct-reduced iron (DRI), scrap, mineral additions, alloying elements, oxygen or hydrogen,
scrap is of different types and are chosen among old scrap, new scrap, prime scrap, home scrap, pit scrap, shredded, plates and structure scrap, heavy melting scrap, cast scrap, coil scrap or busheling scrap,
energy sources are chosen among renewable electricity, electricity produced by internal recycling of exhaust gas from the steel manufacturing process or by capture of heat released by products from the steel manufacturing process,
processes are chosen among coking, sintering, ironmaking, steelmaking, casting, finishing,
processes are chosen among direct reduction processes, hydrogen-based ironmaking, steel electrolysis, blast furnace with top-gas recycling, blast furnace with top-gas conversion, electric-arc-furnace steelmaking, converter steelmaking, scrap melting,
for a given steelmaking unit, at least two different manufacturing routes for the steel product are defined and the calculation of expected level of CO2 emissions is also performed for each said defined manufacturing route and the manufacturing of the product is performed according to the manufacturing route having the lowest calculated expected level of CO2 emissions,
after the manufacturing step, the method includes a step of establishing a certificate for the manufactured steel indicated the expected level of CO2 emissions associated to its manufacturing route.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 is a flowchart of a method, according to the invention, for manufacturing steel

### DETAILED DESCRIPTION

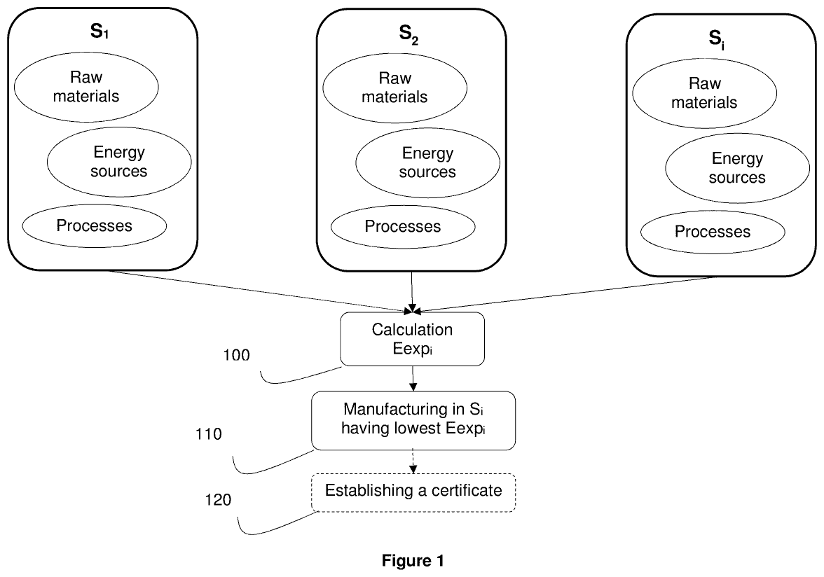

FIG. 1 represents a flowchart of a method to manufacture a steel product according to the invention. A product P may be manufactured into at least two steelmaking units Sᵢ, i being at least equal to two. The steel product may be chosen among liquid steel, steel semi-product, steel flat product, steel long product. Among steel flat product, it may be a slab, a hot-rolled coil, a cold-rolled coil, a sheet, a plate. Among long products, it may be a hot rolled, cold rolled or drawn bar, rebar, railway rails, wire, rope, sections such as U, I, or H section beam, a sheet pile, a bloom, a billet.

By steelmaking unit it is meant a unit comprising all necessary manufacturing tools allowing to produce the considered steel product. A manufacturing tool maybe a combination of several equipment. For example, a blast furnace with top-gas recycling is one tool, even if it comprises a blast furnace, gas treatment devices and gas heating devices. The tools may be chosen among a coking plant, a sintering plant, a direct-reduction plant, a blast-furnace, an electric-arc furnace, a converter, a ladle, a H2 production plant, a chemical plant, a biotech plant, a power plant, a furnace, a casting plant, a rolling plant, gas cleaning devices, heat recovery devices, hot stoves, coating devices.

As a matter of illustration if the considered product is a liquid steel the first steelmaking unit S1 may comprise a blast furnace, a basic oxygen furnace and a ladle furnace. The steelmaking unit S2 may comprise a direct-reduction plant, an electric-arc furnace and a ladle furnace.

In a first step 100, a calculation step is performed wherein an expected level of CO2 emissions EExpi is calculated for each steelmaking unit Si. This calculation 100 is done considering all CO2 contributions linked to raw materials, energy sources and processes used for manufacturing the steel product.

Raw materials may be of different types. They may include coal, coke, iron ore, biomass, sintered ore, agglomerates, pellets, direct-reduced iron (DRI), scrap, mineral additions, such as limestone or dolomite, alloying elements but also gases such as oxygen or hydrogen. Scrap maybe of different typologies among, notably, old scrap, new scrap, prime scrap, home scrap, pit scrap, shredded, plates and structure scrap, heavy melting scrap, cast scrap, coil scrap or busheling scrap. By considering all CO2 contributions linked to raw materials, it is meant that all CO2 emissions linked to the production of those raw materials before they are used into the steel manufacturing process is taken into account. For example, when considering iron ore, all CO2 emissions related to the mining extractions and ore processing have to be included into the calculation. Same for the scrap, even it is the recycling of an existing product, it has a CO2 footprint coming from its former life which has to be considered into the calculation. Depending on its typology, CO2 footprint may differ from one scrap to another.

Energy sources may also be various. They include electricity coming from renewable energy, such as from solar panels or windmills, but also electricity produced by power plant, which may use gases resulting from the steelmaking process, such as blast furnace gases or converter gases. It also includes any fuel, either gaseous or solid, fossil or organic, which may be used into the steel manufacturing process. In a preferred embodiment energy sources are chosen among renewable electricity, electricity produced by internal recycling of exhaust gas from the steel manufacturing process or by capture of heat released by products from the steel manufacturing process.

In order the calculation to be the most accurate it is important to not count a CO2 impact twice. For example, if coke is considered as a raw material to the converter process and its impact included into the raw materials impact, it must not be considered as a fossil fuel and included into the energy sources impact.

Processes include all different processes performed along the manufacturing route and their associated CO2 emissions. It includes pig iron production, liquid steel production and finishing processes. Pig iron production includes coking, sintering, pelletizing, blast furnace process, but also direct reduction and shaft furnace processes. Liquid steel production covers decarburization, dephosphorization and all secondary metallurgy or ladle treatments allowing to turn pig iron into liquid steel and adjust the composition of the liquid steel for further steps, it also includes the electric-arc-furnace steelmaking process. Finishing processes include notably casting, heating, rolling, cooling, coiling, shaping, levelling, welding, coating. When considering CO2 impact of a process, all by-products recycling or emission reduction technologies applied to said process has to be taken into account for the calculation. For example, blast furnace process without top-gas recycling does not have the same CO2 impact as the same blast furnace process wherein top-gas is not released to the atmosphere but rather re-injected into.

In a preferred embodiment, processes are chosen among direct reduction processes, hydrogen-based ironmaking, steel electrolysis, blast furnace with top-gas recycling, blast furnace with top-gas conversion, electric-arc-furnace steelmaking, converter steelmaking, scrap melting. By hydrogen-based ironmaking it is meant any ironmaking process, such as a direct-reduction process or a blast-furnace process wherein the reducing gas is mainly composed of hydrogen. Blast-furnace wit top-gas recycling means a blast furnace process wherein top-gas exhausting from the blast furnace is at least partly re-injected into the blast furnace after appropriate treatments. Blast furnace with top-gas conversion means a blast furnace process wherein top-gas exhausting from the blast furnace is at least partly used to produce a syngas which is then further used in chemical, biochemical or power plants

Once this expected level of CO2 emissions Eexpi is calculated, all Eexpi are compared and the product P is manufactured into the steelmaking unit Si having the lowest expected level of emissions Eexp.

In another embodiment, for a given steelmaking unit Sᵢ different manufacturing route MR_{i,x} allowing to manufacture product P are possible. For example, considering that all necessary equipments are available in the steelmaking unit S1, a slab maybe manufactured from liquid steel produced according to a blast furnace/converter route MR_{1,1} or according to an electric arc furnace route MR_{1,2}. In this embodiment, the calculation step 100 includes calculation of expected level of CO2 emissions for each manufacturing route of each steelmaking unit Eexp_{i,x}. Then, all Eexpᵢ (when only one manufacturing route available for a steelmaking unit Sᵢ) and Exp_{i,x} are compared and the product P is manufactured according to the lowest expected level of emissions of both Eexpᵢ and Eexp_{i,x}.

The method may also comprise an additional step 120, after the manufacturing step 110 of establishing a certificate for the manufactured steel indicated the level Eexpᵢ of CO2 emissions associated to its manufacturing route

With the method according to the invention it is thus possible to produce the steel product P with a reduced carbon footprint and to determine said carbon footprint.

What is claimed is:

1-8. (canceled)

9: A method of manufacturing of a steel product P in at least two steelmaking units Sᵢ, the method comprising the following steps:
a calculation step wherein an expected level of CO2 emissions Eexpᵢ is calculated to manufacture P in each steelmaking unit Sᵢ, such calculation being done considering all CO₂ contributions associated to raw materials, energy sources and processes used for manufacturing the steel product P in each respective steelmaking unit Sᵢ, and
manufacturing the product P into the steelmaking unit Sᵢ wherein the calculated expected level of CO2 emissions Eexpᵢ is the lowest.

10: The method as recited in claim 9 wherein raw materials are chosen from the group consisting of: coal, coke, iron ore, biomass, sintered ore, agglomerates, pellets, direct-reduced iron (DRI), scrap, mineral additions, alloying elements, oxygen and hydrogen.

11: The method as recited in claim 10 wherein scrap is chosen and wherein scrap is of different types and chosen from the group consisting of: old scrap, new scrap, prime scrap, home scrap, pit scrap, shredded, plates and structure scrap, heavy melting scrap, cast scrap, coil scrap and busheling scrap.

12: The method as recited in claim 9 wherein energy sources are chosen from the group consisting of: renewable electricity, electricity produced by internal recycling of exhaust gas from the steel manufacturing process and electricity produced by capture of heat released by products from the steel manufacturing process.

13: The method as recited in claim 9 wherein the processes are chosen from the group consisting of: coking, sintering, ironmaking, steelmaking, casting, and finishing.

14: The method as recited in claim 9 wherein the processes are chosen from the group consisting of: direct reduction processes, hydrogen-based ironmaking, steel electrolysis, blast furnace with top-gas recycling, blast furnace with top-gas conversion, electric-arc-furnace steelmaking, converter steelmaking, and scrap melting.

15: The method as recited in claim 9 wherein, for a given steelmaking unit Sᵢ, at least two different manufacturing routes MR_{i,x} for the steel product P are defined and the calculation of expected level of CO2 emissions Eexp_{i,x} is also performed for each said defined manufacturing route MR_{i,x} and the manufacturing of the product P is performed according to the manufacturing route having the lowest calculated expected level of CO2 emissions of both Eexpᵢ and Eexp_{i,x}.

16: The method as recited in claim 9 further comprising a step, after the manufacturing step, of establishing a certificate for the manufactured steel indicated the level Eexpᵢ of CO2 emissions associated to a manufacturing route.
